(19) United States
(12) Patent Application Publication
(10) Pub. No.: US 2026/0009432 A1
(43) Pub. Date: Jan. 8, 2026

(54) BRAKE MODULE FOR A VEHICLE FLAP DRIVE SYSTEM, AND VEHICLE FLAP DRIVE SYSTEM

(71) Applicant: Stabilus GmbH, Koblenz (DE)

(72) Inventors: David Burbulla, Koblenz (DE); Jan Ginster, Koblenz (DE); Magnus Hümmerich, Dierdorf (DE)

(21) Appl. No.: 19/256,870

(22) Filed: Jul. 1, 2025

(30) Foreign Application Priority Data
Jul. 8, 2024 (DE) 102024119338.7

(51) Int. Cl. F16D 55/225; E05F 5/02; E05F 15/603; F16D 65/00; F16D 65/02; F16D 65/12

(52) U.S. Cl. CPC F16D 55/225; F16D 65/125; E05F 5/022; E05F 15/603; E05Y 2900/50; F16D 65/0006; F16D 2065/1308; F16D 2065/1328; F16D 2200/0021; F16D 2200/006; F16D 2250/00; F16D 2250/0084

(57) ABSTRACT

The invention relates to a brake module (100) for a vehicle flap drive system with at least one first friction partner (130) and at least one second friction partner (160, 170), wherein the friction partners (130, 160, 170) each have at least one friction surface (140, 150, 180, 190) which rub against one another during braking operation, wherein the first friction partner (130) is formed in one piece from a plastic with a carbon fiber content.

The invention further relates to a vehicle flap drive system comprising a brake module (100).

The present invention relates to a brake module for a vehicle flap drive system with at least one first friction partner and at least one second friction partner, wherein the friction partners each have at least one friction surface that rub against one another during braking operation.

In drive systems, particularly in spindle drives such as, by way of example, those known from EP 1 767 439 A2 which are used for vehicle flaps, it is necessary to apply a load torque in order to optimize the force curve when extending and retracting the spindle and when stationary to generate a holding force. On the one hand, this allows a vehicle flap to be held, and on the other it allows a uniform movement of the drive system. Damage due to excessive forces due to the weight of the vehicle flap or due to excessive manual force by the user can also be avoided. Different brake systems are therefore known from the prior art. By way of example, a disk brake with friction partners, a switchable energized brake consisting of electromagnets with friction partners, or a non-switchable hysteresis brake consisting of two permanent magnets are mentioned. However, the known braking systems have various disadvantages, such as noise generation, increased wear, and temperature and speed dependency.

For example, a disk or wrap spring brake with friction partners is not noiseless or odorless and is not independent of temperature and speed. In addition, brakes designed in this way are not wear-resistant and usually contain PTFE.

In addition, switchable, energized brakes consisting of electromagnets with friction partners are not easy to install and require auxiliary power.

In particular, non-switchable hysteresis brakes consisting of two permanent magnets, as well as switchable energized brakes consisting of electromagnets with friction partners, are cost-intensive.

From DE 2023 102 252 U1 a brake module for a drive system is known which has a one-piece brake disk made of plastic.

Similar brake modules are known from the further prior art. DE 10 2018 109 569 A1, for example, describes a brake module with a brake disk and at least one thrust washer. At least one of the friction surfaces of the brake disk and thrust washer has a friction layer for extending the service life and reducing wear, which friction layer is attached to a carrier with an adhesive layer and contains fibers and/or carbon.

Furthermore, DE 2018 101 761 U1 shows a brake arrangement in which an intermediate element is arranged between the brake elements in order to improve their behavior.

The object of the present invention is therefore that of providing a brake module for a vehicle flap drive system which has a long service life, can overall avoid the disadvantages of the known systems, and is also designed to be cost-effective. Furthermore, a vehicle flap drive system with a brake module is to be provided.

The subject-matter of the present invention provides a brake module for a drive system which achieves this object according to the invention, according to the features of claim 1. The object is also achieved by a drive system according to the features of claim 11. Advantageous embodiments result from the dependent claims.

A brake module according to the invention for a vehicle flap drive system comprises at least one first friction partner and at least one second friction partner. The friction partners each have at least one friction surface that rub against each other during braking operation. The first friction partner is made in one piece from a plastic.

According to the invention, the plastic has a carbon fiber content.

The solution according to the invention provides an optimized combination of the friction partners which offers a simple design, is particularly cost-effective and at the same time has a long service life.

Due to the one-piece design in plastic the brake module can be manufactured more easily and cost-effectively, as complex assembly processes and material connections are avoided. The need for a complex and cost-intensive coating with one or more friction layers is avoided. The first friction partner made of plastic is also insensitive to storage.

The carbon fiber content in the plastic ensures long-lasting, low-wear friction between the friction partners. At the same time, the coefficient of friction can be increased and excessive static friction can be avoided. The design according to the invention can thus achieve a low variance in the braking torque.

In the sense of the invention, the term “vehicle flap” is understood to mean a component for at least partially closing an opening of a vehicle. In particular, the vehicle flap can be a vehicle door, an engine hood, a luggage compartment hatch, a cargo compartment door, or a tailgate. The use of the brake module for a device or a structure is also conceivable.

The simple production can be achieved in particular by mixing the carbon fibers as cuttings into the plastic.

In order to provide a compact brake module, the first friction partner is preferably provided as a brake disk and the second friction partner as a thrust washer.

According to an advantageous embodiment of the invention, a second friction partner can be provided on two opposite sides of the first friction partner, wherein the first friction partner has a friction surface facing each of the second friction partners. By using two second friction partners, a longer service life and higher braking force can be achieved without significantly increasing the dimensions of the brake module.

At least one second friction partner can be made of steel, in particular of preferably non-nitrided chromium-5 steel. It has been found that a second friction partner for example in the form of a thrust washer made of non-nitrided chromium-5 steel has a shorter service life than a thrust washer made of nitrided chromium-5 steel, but the vibration and noise development due to friction with a first friction partner, for example a brake disk made of fiber-reinforced plastic, is significantly reduced compared to nitrided chromium-5 steel. Such a brake module according to the invention with thrust washer(s) made of non-nitrided chromium-5 steel nevertheless has a comparable or even longer service life overall than a brake module from the prior art.

The first friction partner can be manufactured particularly easily and cost-effectively by means of an injection-molding process. In this case, the carbon fibers can simply be added to the plastic as cuttings, so that the outstanding mechanical properties of the carbon fibers can be advantageously combined with the simple processing of the plastic, resulting in a brake module that is reliable, lightweight and cost-effective to produce.

Preferably, the friction surface of the first friction partner in each case has a number of depressions for receiving a lubricant. Due to the depressions for receiving the lubricant, it is also possible to optimize the wear resistance and the noise behavior. The depressions serve as a reservoir for a lubricant matched to the friction partners and thus increase the service life of the brake module without requiring large amounts of lubricant.

According to a particularly advantageous development of the invention, the lubricant is free of PFPE, PTFE and silicone, which ensures environmentally friendly application without harmful components.

The first friction partner can be annular and can in particular have a central opening, wherein the central opening preferably is approximately circular—in particular having at least two tooth sections separated from one another by a number of, e.g. one, two, three, four, five, six, or seven, recesses, wherein the tooth sections preferably comprise teeth that project radially inwards. Such a design allows a more flexible connection of the first friction partner e.g. to a drive shaft, in particular a threaded spindle of the drive system. It is thus also easier to install the brake module no earlier than late in the production process of a drive system, and to avoid vibration damage during assembly or to remove it if the brake module is defective. An approximately circular cross-section of the opening can mean, for example, that the cross-section is circular except for the radially inward-projecting tooth portions. The recesses are advantageously evenly distributed around the opening in the peripheral direction of the first friction partner, i.e. with a constant angular spacing from each other, in order to ensure a uniform load on the first friction partner and thus a long service life thereof.

The brake module can comprise a housing in which the first friction partner and the at least one second friction partner are guided, preferably coaxially about a central axis, in particular the longitudinal axis of the drive system, in particular of a threaded spindle, of the drive system, wherein the brake module preferably comprises a cover disk which is connected to the housing, preferably by a latching connection, in such a way that the first friction partner and the at least one second friction partner are held in the housing. The cover disk can, for example, have latching openings in which latching hooks of the housing can engage. Advantageously, the latching connection can be designed such that the cover disk cannot be separated from the housing in a non-destructive manner. This protects components in the housing from tampering.

Preferably, the structure of the brake module along the longitudinal axis is: spring, second friction partner, first friction partner, second friction partner, cover disk. These components are preferably all at least partially enclosed by the housing. A simple assembly of the brake module in the drive system can thus be achieved without the risk of losing a portion of the brake module.

The housing can comprise a number of housing slots whose slot longitudinal axis is advantageously aligned parallel to the longitudinal axis of the drive system. Furthermore, at least one second friction partner can have projections, directed outwards radially from the longitudinal axis, which are shaped to be complementary to the housing slots, so that the housing slots and the projections interact in a form-fitting manner against a rotation of the second friction partner relative to the housing about the longitudinal axis. This prevents the second friction partner from rotating along with the first friction partner during a braking process, which could reduce or even cancel out the braking effect. By aligning the slot longitudinal axis parallel to the longitudinal axis of the drive system, the thrust washer can simply be inserted into the housing along the longitudinal axis during assembly of the brake module. Advantageously, the housing slots are distributed uniformly around the longitudinal axis in the circumferential direction of the housing, i.e. with a constant angular spacing from one another. The housing is thereby uniformly loaded, which increases its service life.

The object according to the invention is also achieved by a vehicle flap drive system comprising a brake module according to any of the preceding embodiments.

The specification of the drive system as an electric spindle drive offers precise controllability and high positioning accuracy, which is particularly important for applications such as the movement of vehicle flaps. Electric spindle drives are characterized by low-noise operation, which increases user comfort and increases acceptance in noise-sensitive environments, such as passenger cars.

The present invention is described below with reference to an embodiment. The drawings, the description, and the claims contain numerous features in combination. A person skilled in the art will expediently also consider the features individually and combine them to form expedient further combinations.

In the drawings:

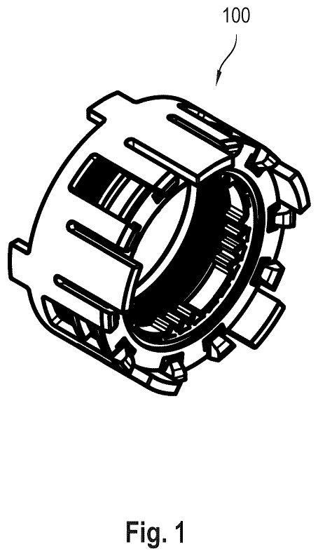

FIG. 1 is a three-dimensional representation of a brake module according to the invention;

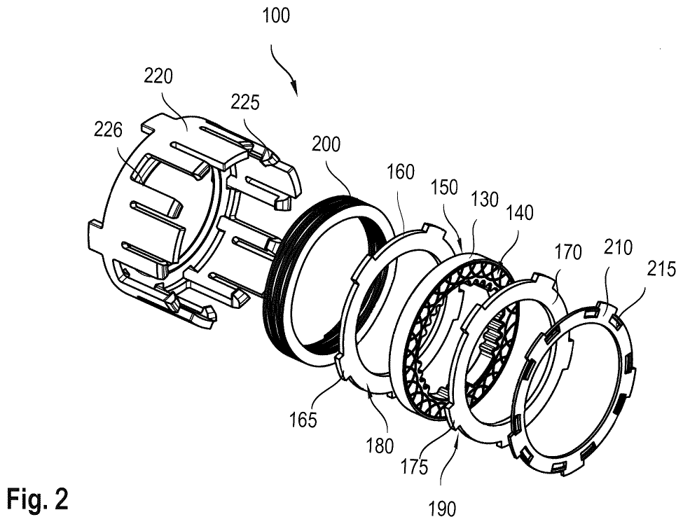

FIG. 2 is an exploded view of the brake module from FIG. 1;

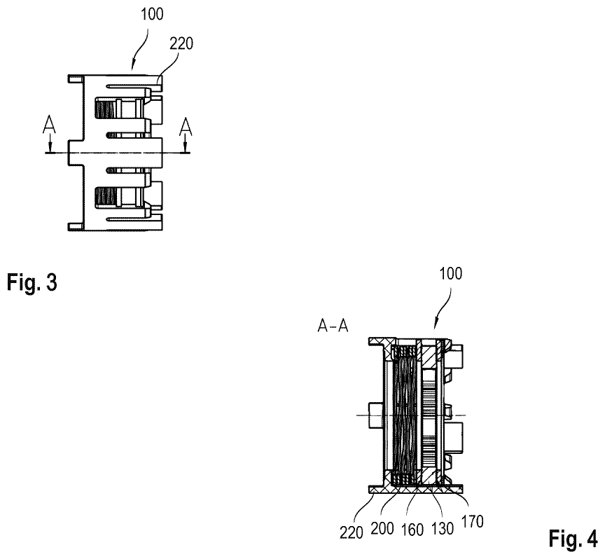

FIG. 3 is a side view of the brake module from FIG. 1;

FIG. 4 is a cross-section A-A of the brake module from FIG. 3;

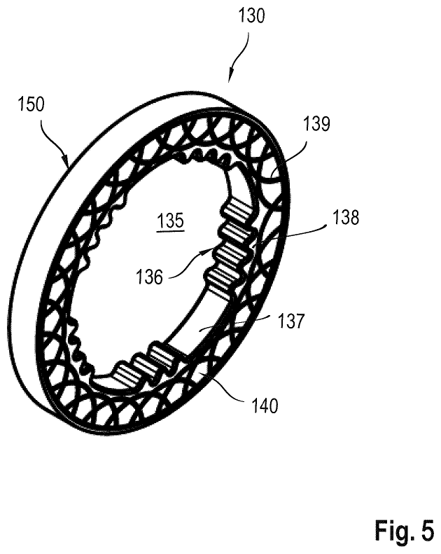

FIG. 5 is an enlarged three-dimensional representation of a brake disk of the brake module from FIG. 1, and

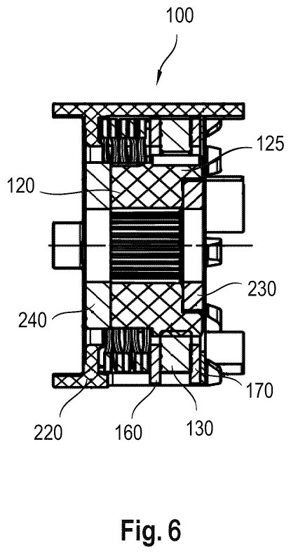

FIG. 6 is a further cross-section of the brake module from FIG. 3 with a driver element of the drive system.

FIG. 1 shows a brake module 100 according to the invention in a three-dimensional representation. The brake module 100 is connected for example via a driver 120 (shown in FIG. 6) to a spindle (not shown) of a vehicle flap drive system. The drive system can be an electric spindle drive, known for example from EP 1 767 439 A2. The spindle is rotationally driven by a drive unit designed as an electric motor, whereby fastening elements of the spindle drive can be moved relative to one another in order for example to open or close a vehicle hatch.

FIG. 2 shows the brake module 100 of FIG. 1 in an exploded view. A first friction partner—here a brake disk 130—comprises at least one, preferably two, friction surfaces 140, 150, which each rub against an adjacent friction surface 180, 190 of second friction partners—here two thrust washers 160, 170—during braking operation, as a result of relative rotation of the brake disk 130 relative to the thrust washers 160, 170 about a longitudinal axis of the spindle or the drive system. A braking torque is thereby exerted on the spindle of the drive system. A spring 200 exerts a spring force along the longitudinal axis on one of the thrust washers 160, whereby the brake disk 130 and the thrust washers 160, 170 are pressed against one another in order to hold them in frictional contact. The strength of the spring force is a parameter via which the magnitude of the braking force can be determined. In this embodiment, the spring 200 is a wave spring.

The brake disk 130, the thrust washers 160, 170, the spring 200, and a cover disk 210 are arranged in a housing 220 in a manner guided coaxially about the longitudinal axis. The housing 220 is connected to the cover disk 210 by a latching connection, whereby the brake disk 130, the two thrust washers 160, 170, and the spring 200 are held in the housing 220. In this case, the cover disk 210 has latching openings 215 in which latching hooks 225 of the housing 220 can engage. The structure of the brake module along the longitudinal axis is thus: spring 200, thrust washer 160, brake disk 130, thrust washer 170, cover disk 210. These components are all at least partially surrounded by the housing 220 when assembled. A simple assembly of the brake module 100 in the drive system can thus be achieved without the risk of losing a part of the brake module 100.

The housing 220 further comprises a number of, e.g. five, housing slots 226 evenly distributed around the longitudinal axis in the peripheral direction of the housing 220, and having a slot longitudinal axis parallel to the longitudinal axis. The projections 165, 175 of the thrust washers 160, 170, which are directed radially outwards from the longitudinal axis, engage in the housing slots 226. This prevents a rotation of the housing 220 and of the thrust washers 160, 170 relative to each other about the longitudinal axis when the brake disk 130 rotates with the spindle and rubs against the thrust washers 160, 170 during braking operation.

The brake disk 130 is annular and has a central opening 135. The central opening 135 has an approximately circular cross-section with at least two, e.g. four, tooth sections 136, uniformly distributed about the longitudinal axis in the peripheral direction of the brake disk 130 and separated from one another by recesses 137. The design of the brake disk 130 can be seen in particular in FIG. 5, which shows an enlarged representation of the brake disk 130. The tooth sections 136 comprise teeth 138 that project radially inwards. Such a design allows a flexible connection of the brake disk 130 to the spindle of the drive system via the driver 120 shown in FIG. 6. The driver 120 comprises wings 125 that engage in the recesses 137 of the brake disk 130. The torque is transmitted between the driver 120 and the brake disk 130 via the contact between the wings 125 and the teeth 138.

As can be seen in particular in FIG. 5, the friction surfaces 140, 150 of the brake disk 130 have a number of depressions 139 for receiving a lubricant, which are designed as overlapping circular segments that are open radially outwards. This geometry allows as much lubricant as possible to remain in frictional contact for as long as possible, so that wear resistance and noise behavior can be optimized.

The depressions 139 thus serve as a reservoir for the lubricant matched to the friction partners and thus increase the service life of the brake module without large quantities of lubricant being required.

The lubricant is particularly free of PFPE, PTFE and silicone, which ensures environmentally friendly use without any harmful components.

The brake disk 130 is formed in one piece from a plastic with a carbon fiber content and is preferably manufactured by means of an injection-molding process. The plastics material of the brake disk 130 is optimized for a friction combination with the thrust washers 160, 170. The carbon fibers added as cuttings also enable long-lasting and low-wear friction, so that the outstanding mechanical properties of the carbon fibers can be advantageously combined with the simple processing of the plastic, resulting in a brake module 100 that is reliable, lightweight and cost-effective to produce.

Due to the one-piece design in plastics material the brake module 100 can be manufactured more easily and cost-effectively by avoiding complex assembly processes and material connections. There is no need for a complex and cost-intensive coating with one or more friction layers. The brake disk 130 made of plastic is also insensitive to storage.

Further disk elements 230, 240 shown in FIG. 6 secure the positioning of the driver 2 on the spindle (not shown) of the spindle drive.

1. Brake module for a vehicle flap drive system with at least one first friction partner and at least one second friction partner, wherein the friction partners each have at least one friction surface which rub against one another during braking operation, wherein the first friction partner is formed in one piece from a plastic having a carbon fiber content.

2. Brake module according to claim 1, wherein the carbon fibers are mixed into the plastic as cuttings.

3. Brake module according to claim 1, wherein the first friction partner is provided as a brake disk and the second friction partner is provided as a thrust disk.

4. Brake module according to claim 1, wherein the second friction partner is provided on two opposite sides of the first friction partner, wherein the first friction partner has one friction surface facing each of the second friction partners, respectively.

5. Brake module according to claim 1, wherein at least one second friction partner consists of chromium-5 steel.

6. Brake module according to claim 1, wherein the first friction partner is produced by means of an injection-molding process.

7. Brake module according to claim 1, wherein the friction surface of the first friction partner in each case has a number of recesses for receiving a lubricant.

8. Brake module according to claim 7, wherein the lubricant is free of PFPE, PTFE and silicone.

9. Brake module according to claim 1, wherein the first friction partner is annular and has a central opening, wherein the central opening has an approximately circular cross-section with at least two tooth sections separated by recesses.

10. Brake module according to claim 1, wherein the brake module comprises a housing in which the first friction partner and the at least one second friction partner are guided, wherein the brake module comprises a cover disk which is connected to the housing by a latching connection in such a way that the first friction partner and the at least one second friction partner are held in the housing.

11. Brake module according to claim 10, wherein the housing comprises a number of housing slots whose slot longitudinal axis is aligned parallel to the longitudinal axis of the drive system, wherein at least one second friction partner has projections directed radially outwards from the longitudinal axis which are shaped to be complementary to the housing slots, so that the housing slots and the projections interact in a form-fitting manner against a rotation of the second friction partner relative to the housing about the longitudinal axis.

12. Vehicle flap drive system comprising a brake module according to claim 1.

13. Vehicle flap drive system according to claim 12, wherein the drive system is an electric spindle drive.
